(19) United States
(12) Patent Application Publication
(10) Pub. No.: US 2005/0255361 A1
(43) Pub. Date: Nov. 17, 2005

(54) Connecting structure and connecting method of fuel cell

(75) Inventor: Shuichiro Saito, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/128,203

(22) Filed: May 13, 2005

(30) Foreign Application Priority Data
May 17, 2004 (JP) 2004-146885

(51) Int. Cl. H01M 8/02; H01M 2/08

(52) U.S. Cl. 429/34; 429/35

(57) ABSTRACT

A connecting structure of a fuel cell for connecting a fuel cartridge containing a gaseous fuel to a fuel cell body and supplying the gaseous fuel to the fuel cell body is provided which comprises a cover member of a fuel supply port provided outside of a valve of the fuel cartridge, a recess of a fuel receiving port provided in the fuel cell body for connection to the fuel supply port, a sealing member of a sealing means for keeping a connecting portion of the fuel supply port and fuel receiving port airtight, and a pin of a valve opening/closing means provided in the fuel cell body for opening/closing the valve after making the connecting portion airtight by the sealing means.

### BACKGROUND OF THE INVENTION

1. Field of the Invention

The present invention relates to connection of a fuel cartridge and a fuel cell body in a fuel cell which uses a gas such as hydrogen as a fuel, and more particularly, to a connecting structure and a connecting method which ensure that a fuel gas does not leak outside when a fuel cartridge is connected to a fuel cell body.

2. Related Background Art

In recent years, environmental breakdown has become a problem and clean energy free from harmful waste materials has been required. Further, the depletion of fossil fuel has become a problem and a new energy source has been requested. On the other hand, in the field of electronics, the amount of information has increased, in connection with which the information processing ability of electronic devices has been improved dramatically and the consumed power tends to increase.

Then, hydrogen which is contained in water existing on the earth exhaustlessly, has a large chemical energy, and does not discharge any harmful material attracts attention as an energy source. In particular, a fuel cell, which takes out directly an electrical energy, can take out a large electric power with good hydrogen-utilization efficiency and has been studied for application to automobiles as well as portable electronic devices such as notebook personal computers, mobile phones, and digital camcorders.

The so-called fuel cell that takes out an electrical energy from hydrogen has a hydrogen electrode, to which hydrogen is supplied, and an oxidizer electrode to which oxygen is supplied and separates hydrogen into electrons and protons by a catalytic reaction in the hydrogen electrode, and the protons pass through an electrolyte membrane to reach the oxidizer electrode, where an electrochemical reaction in which the protons react with oxygen by a catalytic reaction to form water is effected, in the process of which a flow of electrons, that is, an electric power is generated.

With the fuel cell, unlike the conventional cells, it is possible even after exhausting fuel to quickly generate an electrical energy only by resupplying the fuel, without the need of electrical charge, which is convenient for long-time use of a device (International Publication No. WO 03/049223).

### SUMMARY OF THE INVENTION

With the fuel cell, an electrical energy can be taken out anytime, anywhere by resupplying a fuel, but unlike the conventional secondary cell, a gas such as hydrogen will be used. In particular, in a fuel cell, when connecting a fuel cartridge to a fuel cell body, leakage of a fuel gas is liable to occur. When the connection is effected slowly, the connection between the fuel cartridge and the fuel cell body is kept in an unstable state, so that the possibility of leakage will become large especially.

It is, therefore, an object of the present invention to provide a connecting structure and a connecting method of a fuel cell in which after a fuel cartridge and a fuel cell body have been connected to each other and the airtightness of a fuel gas passage through which a gaseous fuel is supplied has been secured, a valve of the fuel cartridge is opened, which makes it possible to use a gaseous fuel safely and also to eliminate undesired consumption of the gaseous fuel due to leakage.

That is, according to a first aspect of the present invention, there is provided a connecting structure of a fuel cell for connecting a fuel cartridge containing a gaseous fuel to a fuel cell body and supplying the gaseous fuel to the fuel cell body, comprising a fuel supply port provided outside of a valve of the fuel cartridge; a fuel receiving port, provided in the fuel cell body, for connection to the fuel supply port; a sealing means for keeping a connecting portion of the fuel supply port and fuel receiving port airtight; and a valve opening/closing means, provided in the fuel cell body, for opening/closing the valve after making the connecting portion airtight by the sealing means.

Further, according to a second aspect of the present invention, there is provided a connecting method of a fuel cell for connecting a fuel cartridge containing a gaseous fuel to a fuel cell body and supplying the gaseous fuel to the fuel cell body, the method comprising connecting a fuel supply port provided outside of a valve of the fuel cartridge to a fuel receiving port provided in the fuel cell body through a sealing means for keeping a connecting portion of the fuel supply port and the fuel receiving port airtight, making the connecting portion airtight by the sealing means, and then opening/closing the valve by a valve opening/closing means provided in the fuel cell body.

According to the present invention, it is possible to provide a connecting structure and a connecting method of a fuel cell by use of which a fuel gas does not leak outside when a fuel cartridge is connected to a fuel cell body and the fuel gas can therefore be treated safely, and undesired consumption of the fuel gas due to leakage does not occur.

### BRIEF DESCRIPTION OF THE DRAWINGS

FIG. 1 is a central sectional view showing a connecting portion of a fuel cartridge and a fuel cell body showing a preferred embodiment of the connecting structure of a fuel cell of the present invention;

FIG. 2 is an exterior view showing a state in which a fuel cartridge and a fuel cell body are connected;

FIG. 3 is a perspective view showing the fuel cartridge of FIG. 2;

FIG. 4 is a perspective view showing the fuel cell body of FIG. 2;

FIG. 5 is a central sectional view showing a connecting portion of a fuel cartridge and a fuel cell body showing another embodiment according to the connecting structure of a fuel cell of the present invention;

FIG. 6 is a perspective view showing the fuel cartridge of FIG. 5; and

FIG. 7 is a perspective view showing an opposite end of the fuel cartridge of FIG. 6.

### DESCRIPTION OF THE PREFERRED EMBODIMENTS

In the present invention, in order to connect a fuel cartridge in which a gaseous fuel is charged, to a fuel cell body and to supply the gaseous fuel to the fuel cell body, a valve for connecting the fuel cartridge to the fuel cell body and a fuel supply port provided outside of the valve are disposed. That is, the present invention is constituted such that when connecting a fuel supply port of the fuel cartridge to a fuel receiving port provided in the fuel cell body, firstly a connecting portion of the fuel supply port and the fuel receiving port is sealed by a sealing member comprising a sealing means to thereby make a fuel passage airtight to the outside, and thereafter, the valve is opened/closed by a valve opening/closing means provided in the fuel cell body.

In the present invention, it is preferable that the sealing means comprises a sealing groove provided in at least one of the fuel supply port and the fuel receiving port and an O-ring comprising an elastic material and disposed in the sealing groove.

Further, it is preferable that the connecting portion of the fuel cell body and the fuel cartridge has a threaded portion.

Moreover, it is preferable that a surface opposite to a surface provided the fuel supply port of the fuel cartridge has an attaching/detaching groove for rotating the fuel cartridge to attach/detach the fuel cartridge to and from the fuel cell body.

### Embodiments

Preferred embodiments of the present invention will be described with reference to the attached drawings.

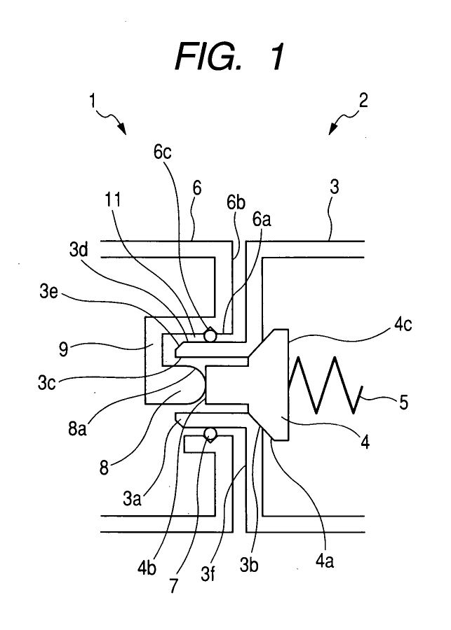

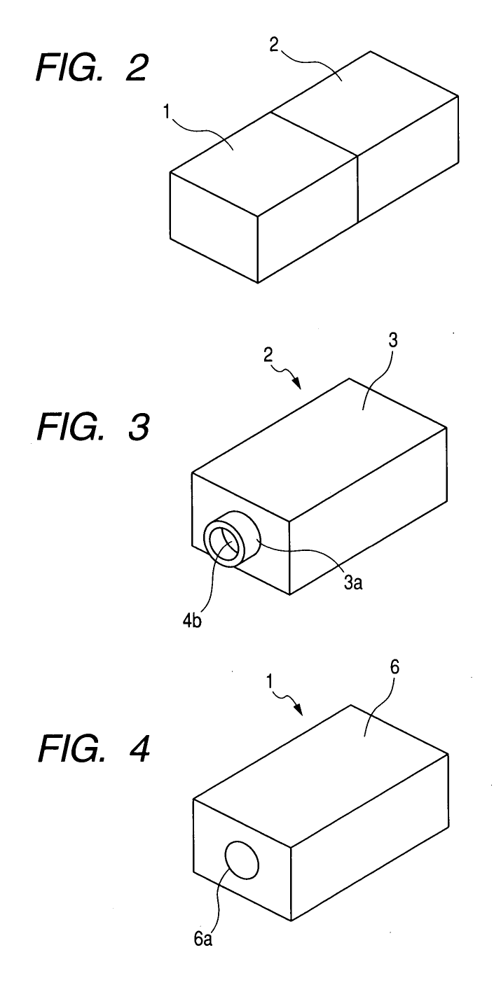

FIG. 1 is a central sectional view showing a connecting portion of a fuel cartridge 2 and a fuel cell body 1 showing a preferred embodiment of the connecting structure of a fuel cell of the present invention. FIG. 2 is an exterior view showing a state in which the fuel cartridge 2 and the fuel cell body 1 are connected. FIG. 3 is a perspective view showing the fuel cartridge of FIG. 2. FIG. 4 is a perspective view showing the fuel cell body of FIG. 2.

In the figures, a cover member 3a serves as a fuel supply port and is provided outside of a valve 4 of the fuel cartridge 2.

A recess 6a serves as a fuel receiving port to which the cover member 3a of the fuel supply port is connected and is provided in the fuel cell body 1.

A sealing means is composed of a sealing groove 6c provided in at least one of the cover member 3a and the recess 6a at a connecting portion 11 of the cover member 3a and the recess 6a, and a sealing member 7 which consists of an O-ring is made of an elastic material and disposed in the groove 6c.

A pin 8 serves as a valve opening/closing means, and after making the connecting portion 11 airtight by use of the sealing means, the pin 8 opens/closes the valve 4 to effect supply/non-supply of the gaseous fuel from a fuel cartridge housing 3 to the fuel cell body 1.

The fuel cartridge housing 3 may have the structure such that compressed hydrogen is charged therein or hydrogen is stored in a hydrogen storage alloy such as a Fe—Ti alloy, a Ti—Mn alloy, or the like. Reference character 3a denotes a cover member explained in detail below, and reference character 4b denotes a protrusion of the valve 4.

FIG. 4 is a perspective view of the fuel cell body, as viewed from the right side in FIG. 2 for convenience of the presentation. Reference numeral 6 denotes a housing of the fuel cell body. Reference character 6a denotes a recess into which the connecting portion of the fuel cartridge is inserted.

FIG. 1 is a central sectional view showing the connecting portion of the fuel cartridge 2 and the fuel cell body 1. In the figure, reference character 3a denotes the cover member, which is located around the protrusion 4b of the valve 4 and protrudes more than the protrusion 4b. A conical surface 4a of the valve 4 is in contact with a conical surface 3b of the fuel cartridge so as to prevent a fuel gas from going outside. Reference numeral 5 denotes a compression spring whose right end in the figure is fixed to a member in the fuel cartridge (not shown), and whose left end is made to depress a bottom surface 4c of the valve 4. That is, a structure is adopted such that the conical surfaces 3b and 4a are in contact with each other by the force of the hydrogen gas pressure and the compression spring 5, so that hydrogen gas may not leak out of the fuel cartridge.

The valve 4 and the cover member 3a are made in sizes smaller than a child's finger so that a child's finger may not reach the protrusion 4b of the valve 4 in a hole 3c of the cover member 3a.

Reference character 6a denotes a recess, and the sealing groove 6c with a V-shape is formed in the interior thereof and an O-ring which is the sealing member 7 is disposed. Reference numeral 9 denotes an L-shaped arm portion which fixes the pin 8. The right side end of the pin 8 in the figure forms a spherical surface portion 8a, which is made to abut against the convex portion 4b of the valve 4.

Next, the operation will be explained.

When the fuel cartridge 2 is inserted into the fuel cell body 1, a chamfer 3e formed at a point of the cover member 3a abuts against the sealing member 7 and the cover member 3a moves leftward in FIG. 1 while compressing the sealing member 7. The sealing member 7 is in close contact with an external surface 3d of the cover member 3a thereby making a fuel passage airtight. Then, when the fuel cartridge housing 3 is further pushed in, the protrusion 4b of the valve 4 and the spherical surface portion 8a of the pin 8 abut against each other. The fuel cartridge 2 is further inserted into the recess 6a while resisting the force of the fuel gas pressure and the compression spring 5, so that the contact between the conical surfaces 3b and 4a are broken, and the hydrogen gas is supplied into the fuel cell body 1 from the inside of the fuel cartridge housing 3.

A surface 3f of the housing 3 of the fuel cartridge 2 and a surface 6b of the housing 6 of the fuel cell body 1 abut against each other, whereby the insertion is completed. The fuel cell body 1 and fuel cartridge 2 are fixed by a fixing member (not shown).

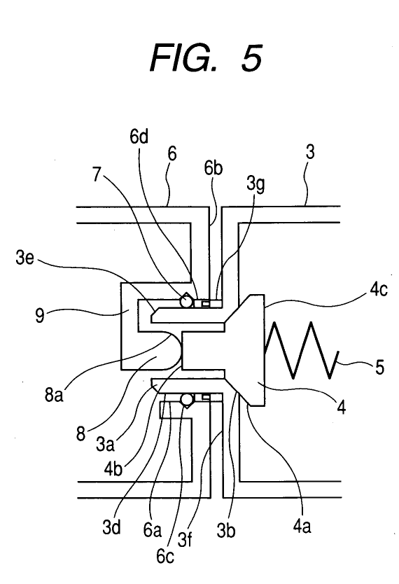

FIG. 5 is a central sectional view showing a connecting portion of a fuel cartridge and a fuel cell body showing another embodiment of the connecting structure of a fuel cell of the present invention.

In the figure, members having no reference numerals are the same as those in FIG. 1. In this embodiment, a thread is used for the connection of the fuel cell body and fuel cartridge. Reference numeral 3g is a threaded portion provided in a cover member 3a.

Reference numeral 6d is a threaded portion provided in a recess 6a. In this embodiment, after the sealing member 7 has been compressed by the recess 6a and the cover member 3a to secure the airtightness of a fuel passage, the threaded portions 3g and 6d engage each other, and in this state, a housing 3 of a fuel cartridge is screwed in to release the valve 4.

FIG. 6 is a perspective view showing the fuel cartridge shown in FIG. 5. As shown in the figure, in this embodiment, a housing 10 is formed in a cylindrical shape so as to rotate the fuel cartridge easily.

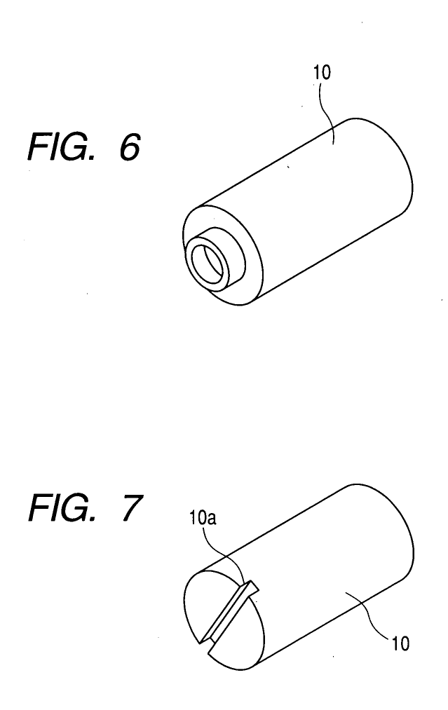

FIG. 7 is a perspective view showing an opposite end of the fuel cartridge shown in FIG. 6. Reference character 10a denotes an attaching/detaching groove, and when the fuel cartridge is to be mounted to the fuel cell body, a coin or the like may be inserted the groove to rotate the housing 10, whereby the fuel cartridge can be mounted easily.

With the connecting structure of the present invention, a fuel gas does not leak outside when a fuel cartridge is connected to a fuel cell body, so that the fuel gas can be used safely and undesired consumption of the fuel gas due to leakage does not occur. Hence, the connecting structure of a fuel cell can be utilized for to automobiles as well as portable electronic devices such as notebook personal computers, mobile phones, and digital camcorders.

This application claims priority from Japanese Patent Application No. 2004-146885 filed May 17, 2004, which is hereby incorporated by reference herein.

1. A connecting structure of a fuel cell for connecting a fuel cartridge containing a gaseous fuel to a fuel cell body and supplying the gaseous fuel to the fuel cell body, comprising a fuel supply port provided outside of a valve of the fuel cartridge; a fuel receiving port, provided in the fuel cell body, for connection to the fuel supply port; a sealing means for keeping a connecting portion of the fuel supply port and fuel receiving port airtight; and a valve opening/closing means, provided in the fuel cell body, for opening/closing the valve after making the connecting portion airtight by the sealing means.

2. The connecting structure of a fuel cell according to claim 1, wherein the sealing means comprises a sealing groove provided in at least one of the fuel supply port and the fuel receiving port, and an O-ring comprising an elastic material disposed in the sealing groove.

3. The connecting structure of a fuel cell according to claim 1, wherein a connecting portion of the fuel cell body and the fuel cartridge has a threaded portion.

4. The connecting structure of a fuel cell according to claim 1, further comprising an attaching/detaching groove, at a surface opposite to a surface provided the fuel supply port of the fuel cartridge, for rotating the fuel cartridge to attach/detach the fuel cartridge to and from the fuel cell body.

5. A connecting method of a fuel cell for connecting a fuel cartridge containing a gaseous fuel to a fuel cell body and supplying the gaseous fuel to the fuel cell body, the method comprising connecting a fuel supply port provided outside of a valve of the fuel cartridge to a fuel receiving port provided in the fuel cell body through a sealing means for keeping a connecting portion of the fuel supply port and the fuel receiving port airtight, making the connecting portion airtight by the sealing means, and then opening/closing the valve by a valve opening/closing means provided in the fuel cell body.

6. The connecting method of a fuel cell according to claim 5, wherein the sealing means comprises a sealing groove provided in at least one of the fuel supply port and the fuel receiving port, and an O-ring comprising an elastic material and disposed in the sealing groove.
